(19) United States
(12) Patent Application Publication
(10) Pub. No.: US 2026/0243106 A1
(43) Pub. Date: Aug. 20, 2026

(54) REMOTE ACTUATOR SYSTEM

(71) Applicant: Southco, Inc., Concordville, PA (US)

(72) Inventors: Jeffrey Alexander Grabner, Concordville, PA (US); Shiwei Mao, Concordville, PA (US); Douglas Griesbach, Concordville, PA (US)

(73) Assignee: Southco, Inc., Concordville, PA (US)

(21) Appl. No.: 19/160,492

(22) PCT Filed: Mar. 1, 2024
(86) PCT No.: PCT/US2024/018050

§ 371 Date: Aug. 28, 2025

Related U.S. Application Data
(60) Provisional application No. 63/449,742, filed on Mar. 3, 2023.

(51) Int. Cl. E05B 47/00; E05B 41/00; G06F 3/044; G06F 3/045; G06F 3/147

(52) U.S. Cl. CPC E05B 47/0001; E05B 41/00; E05B 2047/0058; E05B 2047/0067; E05B 2047/0071; E05B 2047/0095; G06F 3/044; G06F 3/045; G06F 3/147

(57) ABSTRACT

A remote electronic actuator system includes a user interface configured to receive at least one input from a user to operate a latch configured to latch a secured space; and a wired or a wireless communications interface configured to connect the user interface to the latch. Also, a latch system configured for remote actuation includes an electronic actuator; a user interface coupled to the electronic actuator and configured to receive at least one input from a user; a latch configured to latch a secured space; and a wired or a wireless communications interface configured to connect the user interface to the latch.

### CROSS-REFERENCE TO RELATED APPLICATIONS

This application claims priority to U.S. Provisional Patent Application No. 63/449,742, filed on Mar. 3, 2023, titled “REMOTE ACTUATOR SYSTEM,” the entirety of which is incorporated by reference herein for all purposes.

### FIELD OF THE INVENTION

The present invention relates generally to systems for providing controlled access to a secure area, and more specifically to electronic access systems.

### BACKGROUND OF THE INVENTION

Electronic access systems are used to control access to secured areas, including but not limited to data centers, research labs, vaults, storage areas, and other types of enclosures. Some systems feature one or more latches, where each latch facilitates the unlocking and locking of a panel, door or other structure that controls access to the secured area.

Advancements in the area of electronic access systems are continually sought in the interests of performance, security, cost, and operability. There remains a need for new electronic access systems such as, for example, handle/latch assemblies that include the option of remote electrical operation of a handle/latch assembly having at least one of improved performance, security, operability, a simpler user interface, and more cost-effective design.

### SUMMARY OF THE INVENTION

According to an aspect of the invention, a remote electronic actuator system includes a user interface configured to receive at least one input from a user to operate a latch configured to latch a secured space; and a wired or a wireless communications interface configured to connect the user interface to the latch.

According to another aspect of the invention, a latch system configured for remote actuation includes an electronic actuator; a user interface coupled to the electronic actuator and configured to receive at least one input from a user; a latch configured to latch a secured space; and a wired or a wireless communications interface configured to connect the user interface to the latch.

### BRIEF DESCRIPTION OF THE DRAWINGS

FIG. 1 is a block diagram of a remote electronic actuator system according to an embodiment of the invention.

FIG. 2A shows a front view of a remote electronic actuator according to an embodiment of the invention.

FIG. 2B shows a rear view of the remote electronic actuator of FIG. 2A according to an embodiment of the invention.

FIG. 3 is a block diagram of a wired remote electronic actuator system according to an embodiment of the invention.

FIG. 4 shows a wired remote electronic actuator system according to an embodiment of the invention.

FIG. 5 shows a wireless remote electronic actuator system according to another embodiment of the invention.

FIG. 6A is a schematic diagram of a resistive touch sensor according to an embodiment of the invention.

FIG. 6B is a schematic diagram of a capacitive touch sensor according to an embodiment of the invention.

FIG. 7A shows a rear perspective view of a remote electronic actuator according to an embodiment of the invention.

FIG. 7B shows another rear perspective view of the remote electronic actuator shown in FIG. 7A.

FIG. 7C shows an exploded view of the remote electronic actuator shown in FIG. 7A and FIG. 7B.

FIG. 8 is a block diagram of a remote electronic wireless actuator according to an embodiment of the invention.

FIG. 9 is a block diagram of a secure wired remote electronic actuator system according to an embodiment of the invention.

FIG. 10 is a block diagram of a wireless remote electronic actuator system according to an embodiment of the invention.

FIG. 11 is a block diagram of a remote wireless latch module according to an embodiment of the invention.

FIG. 12 is a block diagram of a wireless remote electronic actuator system according to another embodiment of the invention.

FIG. 13A shows a front perspective view of a remote electronic wireless actuator according to an embodiment of the invention.

FIG. 13B shows a front perspective view of a remote electronic wireless actuator according to an embodiment of the invention.

FIG. 13C shows a front perspective view of a remote electronic wireless actuator according to an embodiment of the invention.

FIG. 13D shows a top view of a remote electronic wireless actuator according to an embodiment of the invention.

FIG. 14A shows a rear perspective view of a remote electronic wireless actuator.

FIG. 14B shows a rear perspective view of a remote electronic wireless actuator.

FIGS. 15A and 15B show a side view of a remote electronic wireless actuator.

### DETAILED DESCRIPTION OF THE INVENTION

The invention will now be described by reference to exemplary embodiments and variations of those embodiments. Although the invention is illustrated and described herein with reference to specific embodiments, the invention is not intended to be limited to the details shown and described. Rather, various modifications may be made in the details within the scope and range of equivalents of the claims and without departing from the invention.

Latches optionally include built-in user interfaces, such as actuators or “readers,” for example, that receive an input from a user seeking to access a secure area. Depending on the type of input, the input may be converted to a signal and sent to a controller. If the user's input is accepted, a controller will send a signal to unlock each latch. One type of actuator/latch assembly, for example, uses rods or mechanical cables to attach the user interface, such as an actuator or a “reader,” for example, to the latch. In many applications, an electrically operated latch is desirable due to the need for remote or push-button entry, coded access, key-less access, or monitoring of access.

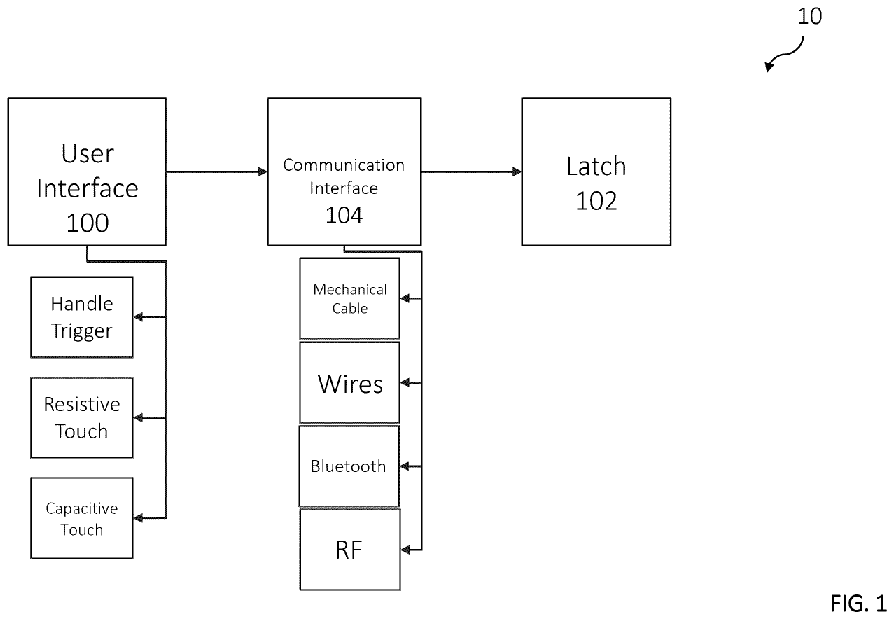

Referring generally to the figures, a remote actuator system 10 for providing controlled access to a secure area is disclosed. The system 10 generally includes a user interface 100 (FIG. 1) configured to receive input from a user to operate a latch module 102. The user interface 100 and the latch module 102 are connected to each other via a wired or a wireless communications interface 104, for example.

The latch module 102 includes at least one latch and is configured for mounting to a panel (not shown) that provides access to a secure area. Once installed to the panel, the latch module 102 is operable in two different modes to control access to the secure area. In particular, the latch module 102 is operable in a locked mode to lock the panel and prevent access to the secure area. The latch module 102 is also operable in an unlocked mode to unlock the panel and allow access to the secure area.

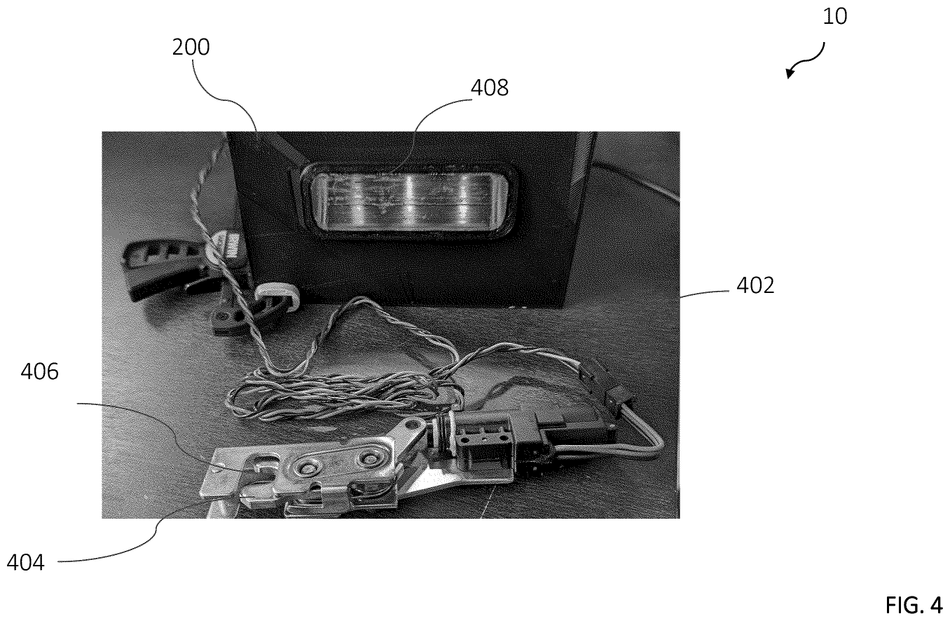

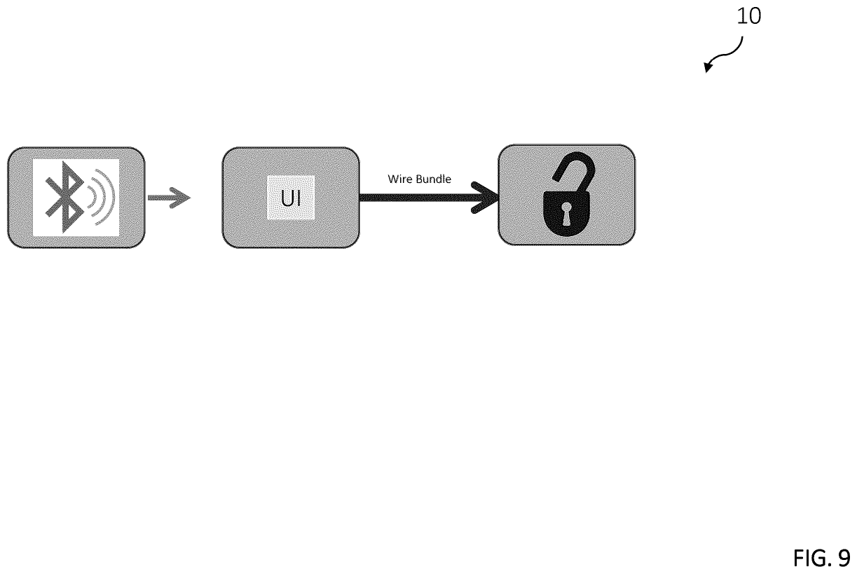

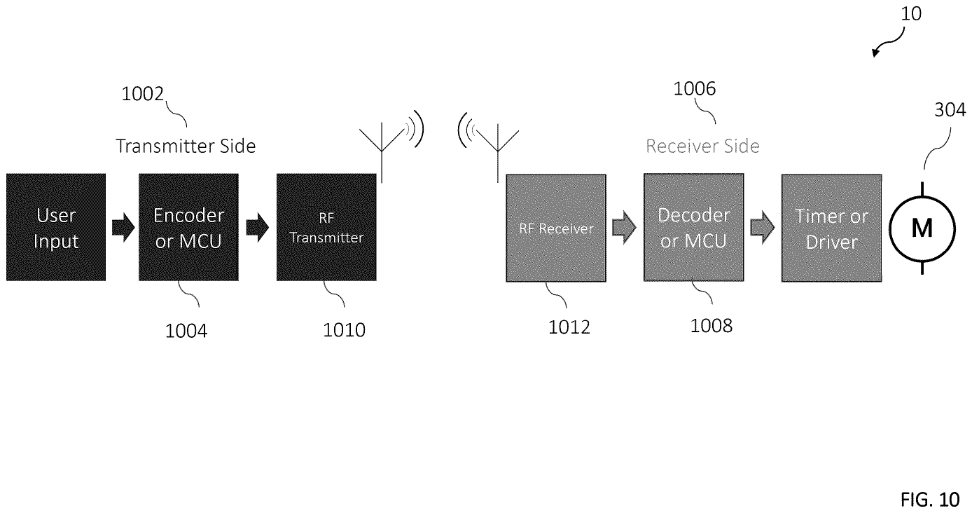

The communications interface 104 may be a wired connection (as shown in FIG. 4, for example), a wireless connection (as shown in FIG. 10, for example), or a combination of wired and wireless connection (as shown in FIG. 9, for example).

When the communications interface 104 is a wired connection, the communications interface 104 can include at least one cable or wire 402 (FIG. 4), or a bundle of cables or wires 402.

When the communications interface 104 is a wireless connection, the communications interface 104 can include a wireless communications protocol, such as Bluetooth®, Near Field Communications, WiFi, WPAN (such as ZigBee or Z-Wave), or a Radio Frequency (RF) communications protocol and/or WLAN (WiFi/802.11) protocol, long range (LoRa) or LoRaWAN protocols, RFID, Cellular, etc., for example, for wirelessly communicating with the latch module 102 and with external devices.

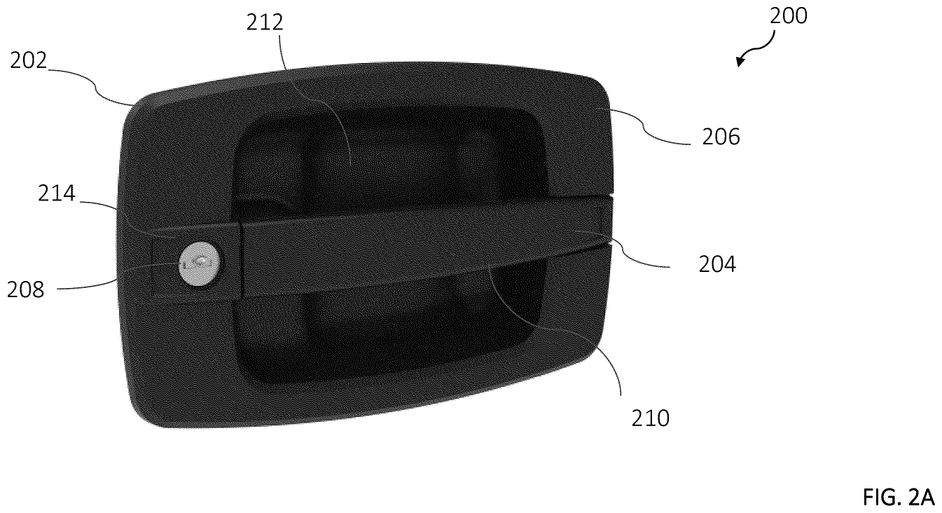

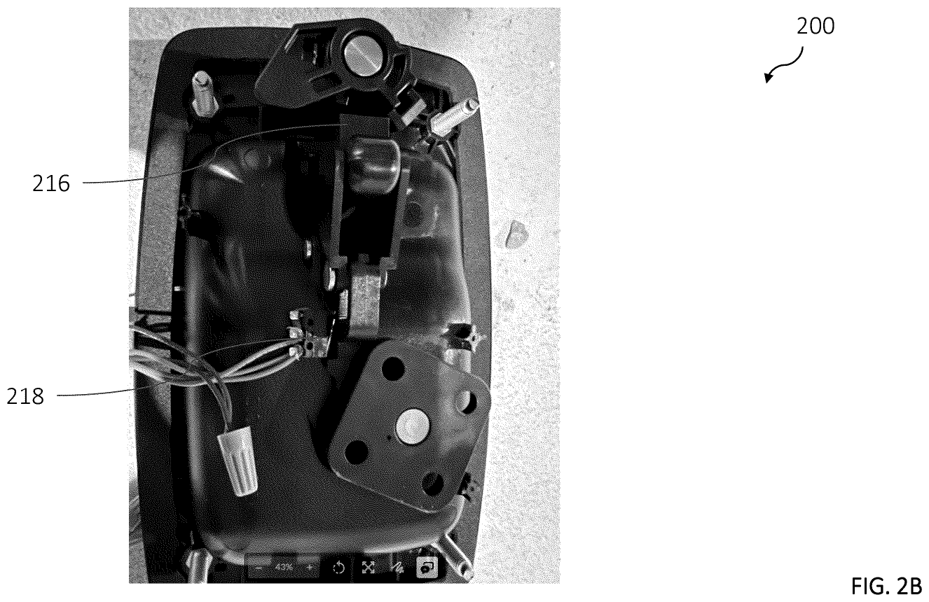

The functions of the user interface 100 can be performed by a remote actuator 200 (shown in FIGS. 2A and 4, for example) or by a mobile device, such as mobile phone, tablet, smart watch, etc., for example.

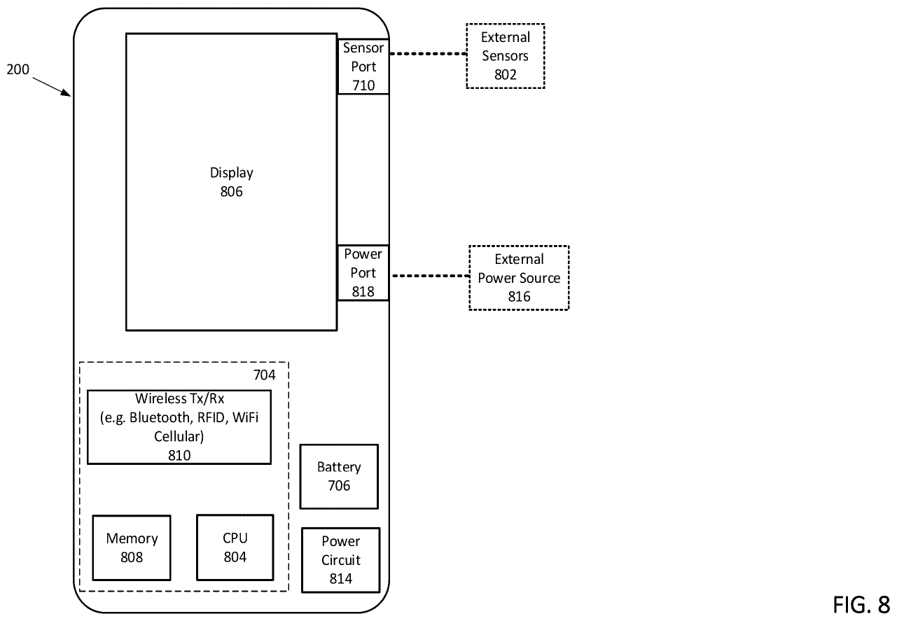

Referring now to FIG. 2A, a remote actuator 200 performs the functions of the user interface 100 of the remote actuator system 10. The remote actuator 200 can include a handle trigger 204/210, at least one sensor 802 (shown in, and described with reference to, FIG. 8), or a combination of a handle trigger and one or more sensors.

As shown in FIG. 2A, for example, the remote actuator 200 includes a housing 202 defining an interior space for accommodating various components of the system 10, and a handle 204 that is mounted to the front face 206 of the housing 202. The handle 204 has an elongated handle portion 210 extending along the width of the housing 202 and configured for gripping by a user. A recessed area 212 is provided in the housing 202 between the elongated handle portion 210 of the handle 204 and the housing 202, to allow the user to insert his/her hand or one or more fingers to grip the handle 204. A mechanical key-lock 208 may also be provided on the handle 204 to allow the user to unlock and lock the remote actuator 200. A lever 216 operatively connected to a microswitch or a sensor 218 (shown in FIG. 2B) may be provided on the back of the remote actuator 200 in a location corresponding to the location of the key-lock 208. Once the key-lock 208 is unlocked, a switch-actuator portion 214 (FIG. 2A) can accept user input (e.g., push or press on the switch-actuator portion 214), such that the latch module 102 can switch between a locked mode and an unlocked mode based on the user's interaction with the switch-actuator portion 214.

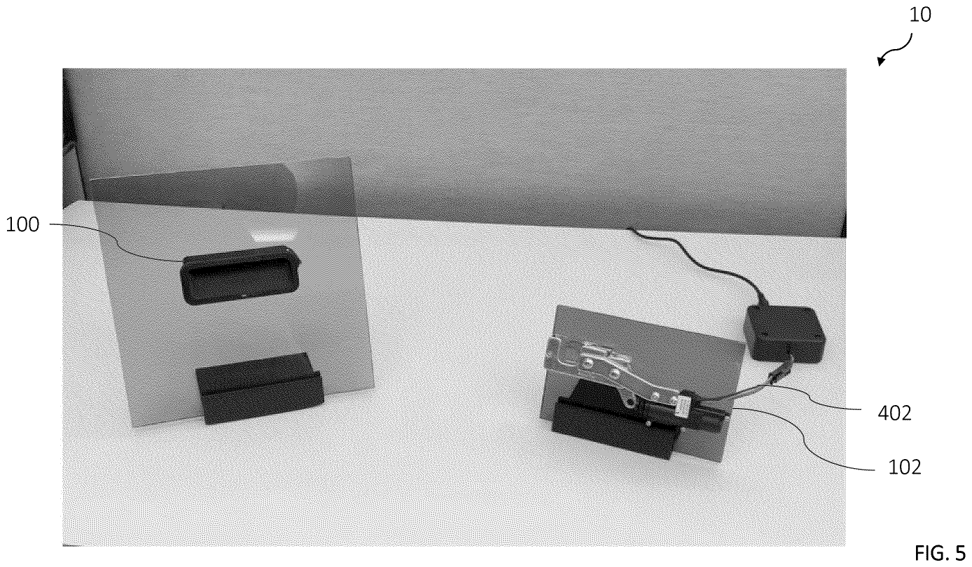

It should be understood that the geometry and structure of the remote actuator 200 may vary, and could have different shapes and configurations, such as the configurations illustrated in FIGS. 4 and 5, for example. Remote actuators in accordance with the present disclosure may take the form of an L-handle, a T-handle, a swing handle, or other type of actuator which can be manually or remotely operated to open and close the closure.

Turning back to FIG. 2A, the elongated handle portion 210, which is connected to front side 206 of the housing 202, can be manually operated to open the panel (not shown) securing an area when the latch module 102 is in the unlocked mode. The latch module 102 can switch between a locked mode and an unlocked mode based on the user's operation of the handle trigger 204/210 or the switch-actuator portion 214. The user's action of opening the remote actuator 200 will trip the microswitch 218 (or a sensor), and an output from the microswitch 218 (or the sensor) will be used to drive an actuator to open the latch module 102.

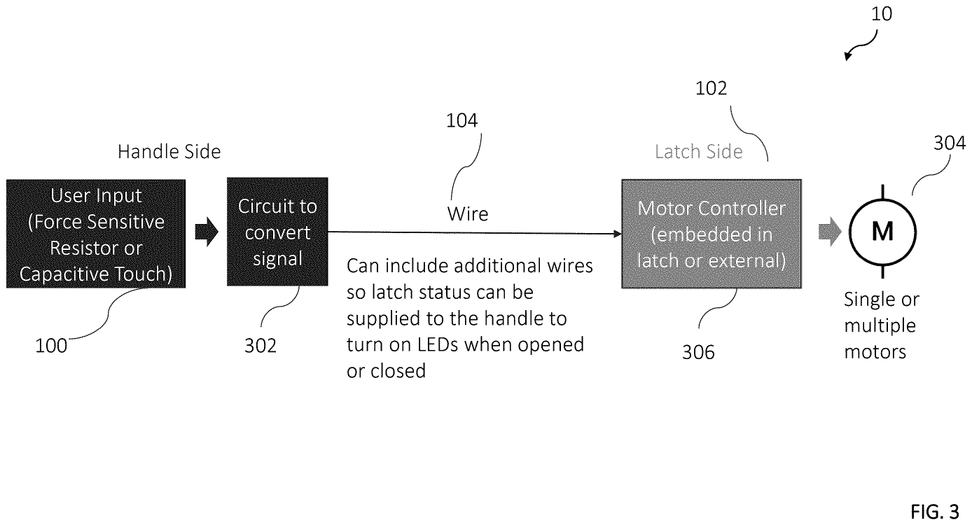

FIG. 3 illustrates a block diagram of a wired remote actuator system 10 according to an embodiment of the invention. The functions of the user interface 100 in this configuration are performed by a remote actuator 200 (shown in FIGS. 2, 4, and 5). On the actuator 200 side, the user interface 100 is configured to accept user input. The user input can be provided in the form of gripping the elongated handle portion 210 of the handle 204 by the user and pulling the handle 204 toward the user, by pressing the switch-actuator portion 214, or by the presence of the user in the proximity of the actuator 200 by a proximity sensor included in the actuator 200, as described below.

The actuator 200 can also include a circuit configured to convert the signal from the handle trigger 204/210 (or the switch-actuator portion 214 or the proximity sensor) and supply the converted signal, via the communications interface 104, to the latch module 102, such that the latch module 102 can switch between a locked mode and an unlocked mode based on operation of the handle trigger 204/210 (or the switch-actuator portion 214 or the proximity sensor). As shown in FIG. 3, the communications interface 104 in this configuration can include at least one cable or wire 402 or a bundle of cables or wires 402 (best shown in FIG. 4).

On the latch module 102 side, an electro-mechanical actuator 304 (e.g., solenoid, motor, etc.) may be provided for actuating the latch by retracting or extending a pawl 404 (FIG. 4), for example. The electro-mechanical actuator 304 can be controlled by a motor controller 306, which can be an external controller or a controller embedded in the latch module 102, as described, for example, in U.S. Patent App. No. 63/224,310 to Southco, Inc., which is incorporated by reference herein in its entirety. In general, the motor controller 306 can include devices, such as a microprocessor, memory devices (e.g. RAM, ROM, etc.), analog input/output (I/O), digital I/O, etc. (not shown), which serve to perform various operations. The memory of the motor controller 306 generally stores the programming for the motor controller 306. Specifically, the memory stores instructions that, when executed by motor controller 306, cause the motor controller 306 to lock and unlock the latch module 102, display the status (e.g., locked or unlocked) of the latch module 102, etc.

Turning back to FIG. 4, as the motor 304 is activated, the pawl 404 is positioned for disengagement from a locking groove 406 of the latch module 102 when the pawl 404 moves toward, or is, in the retracted position.

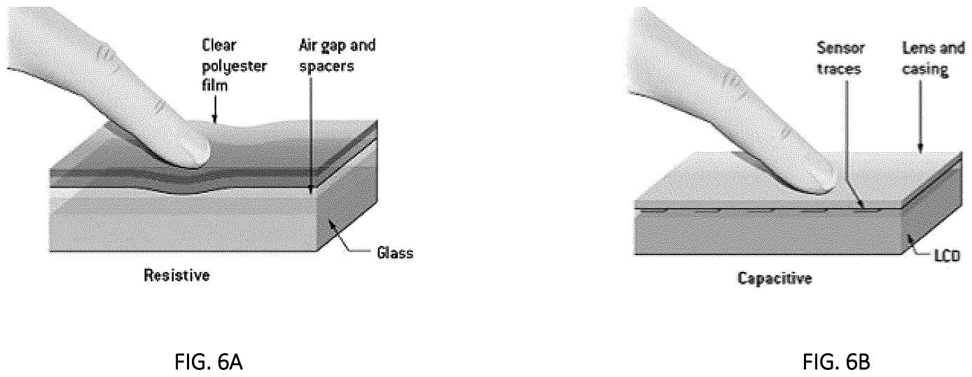

Alternatively to using the handle trigger 204/210 (or the switch-actuator portion 214), the user input can be provided in the form of the user touching or pressing against the surface of the internal portion of the elongated handle portion 210 of the handle 204. To enable this functionality, one or more sensors 802 (shown in FIGS. 6A, 6B, and 8) may be provided on the internal portion (e.g., facing the recessed area 210) of the elongated handle portion 210 of the user interface 100 (e.g., the actuator 200 in this configuration), for example, such that the user can touch or press on these sensors. No contact by the user will be required when the sensors 802 are proximity sensors, and the detection of the user in the vicinity of the sensors 802 will serve as a user input.

The user's input provided by touching or pressing on, or being present in the proximity of, the sensors 802, for example, is interpreted by a circuit 302 (FIG. 3) that is configured to convert the signal from the sensors 802 and supply the converted signal, via the communications interface 104, to the latch module 102, such that the latch module 102 can switch between a locked mode and an unlocked mode based on the user's interaction with the sensors. The sensors 802 can be capacitive touch sensors, infrared proximity sensors, resistive touch sensors, such as a Force Sensitive Resistor (FSR), or the like, for example, that serve as input devices for interfacing with a variety of controls and displays on the user interface 100.

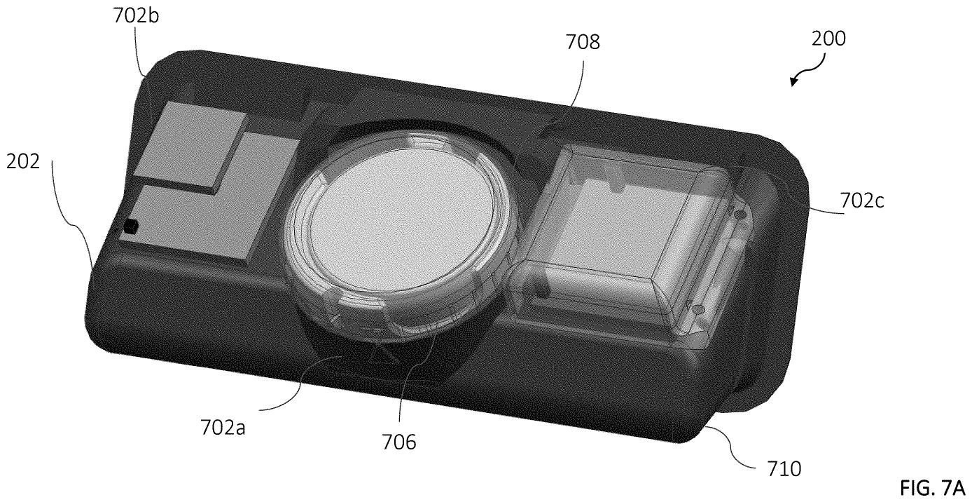

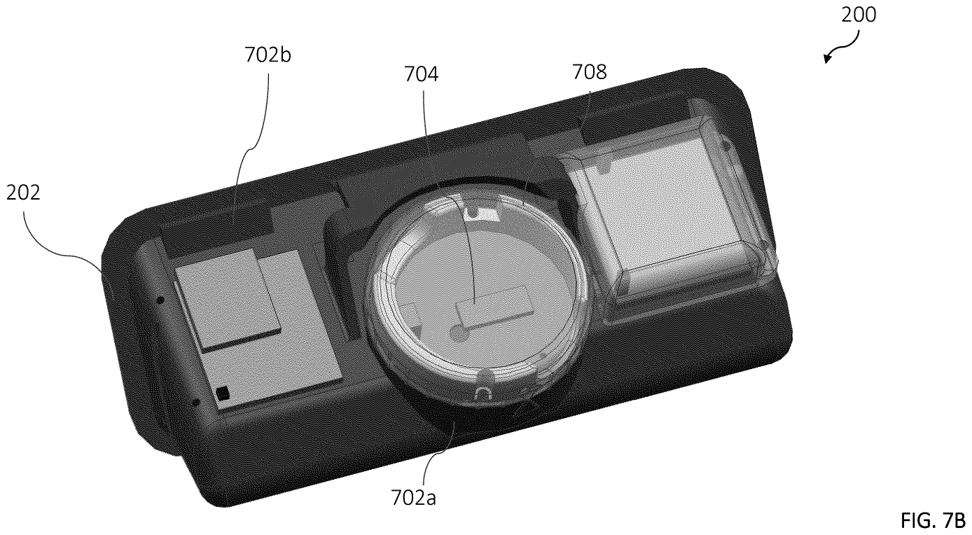

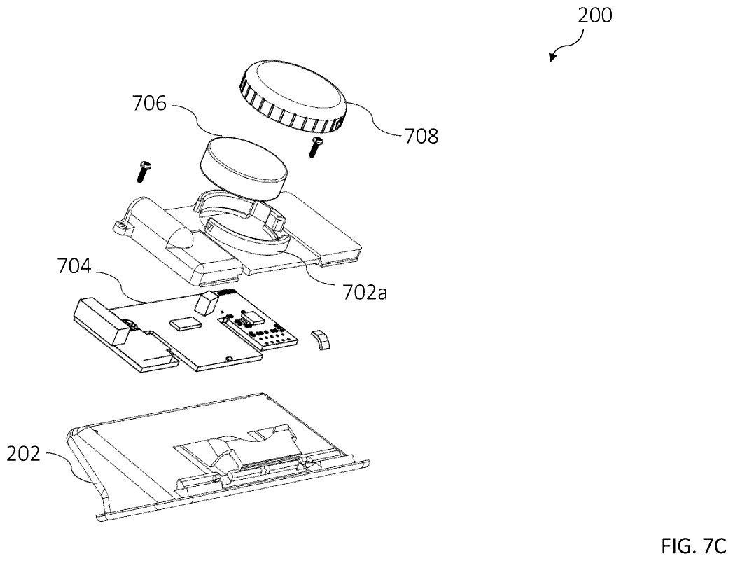

As shown in FIG. 6A, when the sensors 802 are resistive touch sensors, such as Force Sensing Resistors (FSR), the physical pressure of the user's finger produces a compression of a membrane-like flexible substrate that is printed with two normally unconnected halves (e.g., polyester film and glass) of an interdigitated circuit. An air gap between the two halves and spacers affixed to the substrate create a small separation between the two substrates. When the sensor is in a neutral state (e.g., not actuated), the circuit remains open, and electricity cannot pass from one half to the other. When force (e.g., physical pressure of the user's finger) is applied to the sensor, the conductive substrate makes contact with the printed circuit substrate, allowing electricity to flow from one half to the other. The amount of electricity that flows within the circuit depends on the pressure exerted on the FSR, as greater pressure brings more of the conductive material in contact with the substrates and increases the electrical output in a predictable way, allowing the sensor to detect changes in force as well. The FSR sensors 802 are operatively connected to a printed circuit board (PCB) 704 (FIGS. 7B and 8), which can include separate circuitry (e.g., FSR sensor integrated circuits) for detecting a user's pressure on the user interface 100, such as by determining a change in the measured resistance due to the user's pressure, for example.

As shown in FIG. 6B, when the sensors 802 are capacitive touch sensors, only a touch (without compression) of the user's finger produces a change in the capacitance between the two overlapping electrodes because the user's finger acts as an additional conductor of the system. A conductive coating, such as conductive ink or a foil, is applied to the rear surface of the user interface 100 (e.g., the handle trigger 204/210 in this configuration) to define touch areas. The touch areas can have various regular or irregular shapes. The touch areas are operatively connected to a printed circuit board (PCB) 704 (FIGS. 7B and 8), which can include separate circuitry (e.g., touch sensor integrated circuits) for detecting a user's touches on the user interface 100, such as by determining a change in the measured capacitance due to the user's touch, for example.

Capacitive sensors can also be configured to be low range proximity sensors.

The sensors 802 can be controlled by a controller (CPU 804 in FIG. 8), such as a microprocessor, for example, which can be an external controller or a controller embedded in the actuator 200. The controller 804 can interpret the signals from the sensors 802 to determine the activity of each user input, as well as the lock position. For example, input from the sensor(s) may be configured to couple the actuator 200 to the latch module 102.

Referring now to FIG. 7A, the back of the housing 202 of the remote actuator 200 defines an interior space with one or more recessed areas 702a-702c for accommodating various components of the system 10. For example, one of the recessed areas 702a may have a round shape configured to house a coin cell battery 706. The recessed area 702a may have a cover 708 to protect the battery 706 and any other components housed in the recessed area 702a. A sensor port 710 can be arranged in the shape of a rectangular slot, for example, on the back side of the housing 202. The sensor port 710 is configured to accommodate at least one sensor 802 (shown in FIGS. 6A, 6B, and 8, for example) configured for coupling the remote actuator 200 to the latch module 102. As discussed above, the sensor 802 can be a resistive touch sensor, such as a Force Sensitive Resistor (FSR), for example, a capacitive touch sensor, or an infrared proximity sensor, for example. When the communication between the remote actuator 200 and the latch module 102 uses a Radio Frequency (RF) communications protocol, additional recessed areas 702b and 702c, for example, may be provided on the back of the housing 202 of the remote actuator 200 to accommodate separate printed circuit boards for an RF transmitter and an RF receiver.

Turning back to FIG. 4, the remote actuator 200 can include a display 408 for displaying information to the user regarding the status (e.g., unlocked or locked) of the latch module 102, the battery level, etc. The display 408 can include at least one, or a plurality of, liquid-crystal display (LCD), E-ink, or a light-emitting diode(s) (LED). The LEDs can be multi-color light-emitting diode (LED), such as RGB (Red, Green, Blue) LEDs, for example, capable of emitting red, green and blue light, depending on the status (e.g., unlocked or locked) of the latch module 102, for example. The display 408 can further be configured to display status of connected devices, Bluetooth® connection, battery status, status of the sensors 802 (e.g., enabled or disabled), as discussed further below, etc.

Referring now to FIG. 7B, the round recessed area 702a formed on the back of the housing 202 of the remote actuator 200 can also house a printed circuit board (PCB) 704. The PCB 704 is illustrated in FIG. 7B with a round shape, but other shapes and configurations are possible. The sensor 802 is operatively connected (e.g., wired) to the PCB 704. Alternatively, the sensor 802 can be a part of a printed circuit assembly (“PCA”). For example, the sensor 802 can be a capacitive touch sensor that, along with all other electronic components, can be built into a single PCA. The remaining components in FIG. 7B are the same as the ones in FIG. 7A, and will not be repeated for the sake of brevity.

FIG. 7C shows an exploded view of the remote electronic actuator shown in FIG. 7A and FIG. 7B.

FIG. 8 is a block diagram of the remote actuator 200. The remote actuator 200 includes a PCB 704 (also shown in FIG. 7B). The PCB 704 includes at least a microprocessor CPU 804 for controlling various components within the remote actuator 200, memory 808 (e.g., RAM, ROM, etc.) for storing data for the CPU 804, a wireless transceiver 810 (e.g., Bluetooth®, WiFi, RFID, Cellular, etc.) for wirelessly communicating with the latch module 102 and external devices. The memory 808 can be integrated into the microprocessor CPU 804. The remote actuator 200 can further include a display 806 (e.g., LCD, E-ink, LED, etc.) for displaying information to the user of the remote actuator 200, a battery 706 (also shown in FIG. 7A) (e.g., rechargeable, replaceable, etc.) for powering the remote actuator 200, power circuit 814 (e.g., charging circuit, voltage regulator, etc.) for charging the battery 706 from an external source 816 via power port 818 (e.g., micro-USB) and supplying conditioned voltage to the components of the remote actuator 200, and sensor port 710 (also shown in FIG. 7A) for connecting the external sensors 802 to the remote actuator 200.

Optionally, an RFID tap point or an NFC tag (not shown) for tapping or interaction with an RFID card or a mobile device, respectively, may be provided on the remote actuator 200 for providing authorized user access to the latch module 102. It is noted that the specific electrical interconnections between these components are not expressly shown in FIG. 8 for the sake of clarity. Such electrical interconnections would be apparent to those skilled in the art.

Turning back to FIG. 8, the wireless transceiver 810 is operatively connected to the at least one sensor 802. The wireless transceiver 810 is configured to perform wireless communication with the latch module 102 and can be configured to perform wireless communication with one or more wireless components external to the latch module 102, such as a mobile phone, tablet, smart watch, etc., for example.

FIG. 9 is a system diagram of another embodiment of a secure wired remote actuator system 10 according to an embodiment of the invention. Similar to the system illustrated in FIG. 3, the functions of the user interface 100 in this configuration are performed by the remote actuator 200 (shown in FIGS. 2, 4, and 5). However, in the system illustrated in FIG. 9 the user first enables the operation of the remote actuator 200 by activating power to actuate the motor 304 (FIG. 10), and enable the remote actuator 200 to allow input from the sensors 802 (e.g., FSR), using an associated proprietary mobile application (or “app”) (e.g., a computer program, algorithm, or software application) downloaded to, and installed on, a “smart” mobile device. The operation of the remote actuator 200 is normally inactive unless enabled by the user. Alternatively, a firmware or software code embedded into the microprocessor CPU 804 or programmed into the memory 808, which can be integrated into the microprocessor CPU 804, can automatically check the connection and execute an authorization logic.

The system illustrated in FIG. 9 is “secure” in the sense that the app typically requires user credentials (e.g., login and/or authentication) and can be stored on a mobile phone or tablet, for example, that may also require user credentials to generally access any content on the mobile device. The remote actuator 200 and the app can communicate with each other via a standard wireless protocol, such a Bluetooth® protocol, for example. However, embodiments are not limited thereto. For example, the sensors 802 and the app may communicate via one or more wireless links and/or protocols. Example wireless links and/or protocols may include WPAN (such as ZigBee or Z-Wave), low power links (such as Bluetooth LE (BLE), Bluetooth Smart, iBeacon), near field communication protocols (such as NFC) and/or WLAN (WiFi/802.11) protocols, long range (LoRa) or LoRaWAN protocols, and any other suitable wireless links and protocols. A Bluetooth® wireless protocol, for example, can be configured as a bidirectional connection that can allow transmission and reception between the remote actuator 200 and the app via the same connection.

Turning back to FIG. 9, after the remote actuator 200 is enabled to allow input from the sensors 802 (e.g., FSR), the remote actuator 200 is configured to unlock or lock the latch module 102 when the user interacts with the user interface 100 in the same manner as described with reference to FIG. 3 above, and will not be repeated for the sake of brevity.

FIG. 10 is a system diagram of a wireless remote actuator system 10 according to an embodiment of the invention. The functions of the user interface 100 in this configuration are performed by a wireless transmitter 1002. The wireless transmitter 1002 can be part of the remote actuator 200 or an external wireless device, such as a mobile phone, tablet, smart watch, etc., for example.

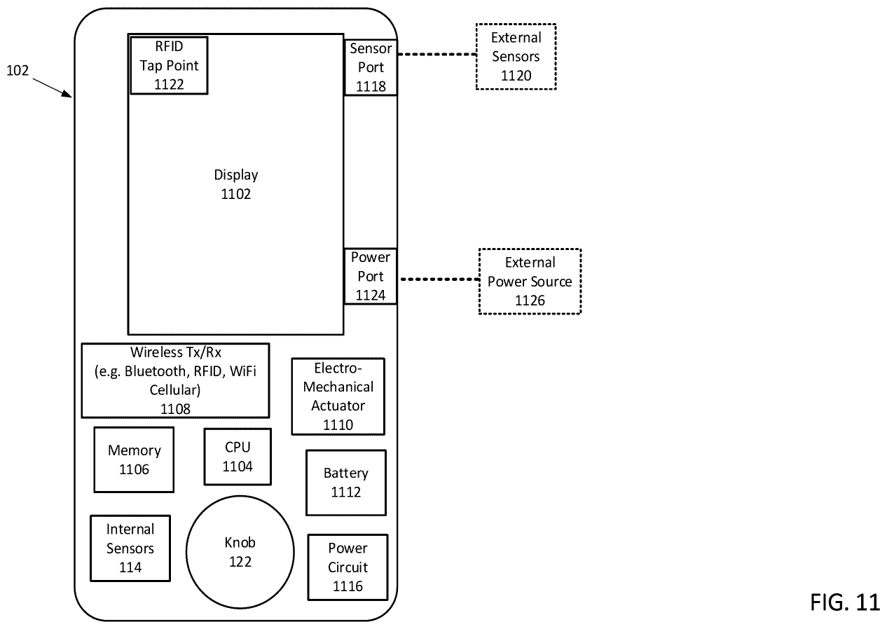

The wireless transmitter 1002 is operatively connected (e.g., wired) to at least one of the sensors 802 (e.g., FSR) and/or the latch module 102. The wireless transmitter 1002 can be included in the PCB 704 (FIG. 8) or can be provided as a separate component on another PCB of the remote actuator 200. The functions of the wireless transmitter 1002 can be performed by a wireless transceiver 1108 (FIG. 11) or a separate wireless transmitter 1002 can be provided as a separate component on the PCB 704. The wireless transmitter 1002 can include an encoder 1004 that converts the signals transmitted by the sensors 802 (e.g., FSR) in digitized form. Alternatively, the functions of the encoder 1004 can be performed by a microprocessor (MCU) that can be part of the microprocessor CPU 804 or a separate processor (e.g., a Bluetooth® on-board signal processor). After the signals transmitted by the sensors 802 (e.g., FSR) are encoded by the encoder 1004 (or the MCU), the wireless transmitter 1002 transmits the encoded signals to a wireless receiver 1006 of the latch module 102.

The wireless receiver 1006 of the latch module 102 can include a decoder 1008 that decodes the encoded signals to provide a suitable signal for the operation of the driver (e.g., motor controller 306 in FIG. 3) and the motor of the latch module 102 to unlock or lock the latch module 102. Alternatively, the functions of the decoder 1008 can be performed by a microprocessor (MCU) that can be part of the latch module 102 or a separate processor (e.g., a Bluetooth® on-board signal processor).

When the communication between the remote actuator 200 and the latch module 102 uses a Radio Frequency (RF) communications protocol, the functions of the wireless transmitter 1002 can be performed by an RF transmitter 1010 of the remote actuator 200 and the functions of the wireless receiver 1006 of the latch module 102 can be performed by an RF receiver 1012.

In the configuration illustrated in FIG. 10, the latch module 102 is configured for wireless communications and can include a printed circuit board. More specifically, and referring particularly to FIG. 11, a wireless latch module 102 includes CPU 1104 for controlling various components within the wireless latch module 102, a display 1102 (e.g., LCD, E-ink, LED, etc.) for displaying information to the user of the wireless latch module 102, memory 1106 (e.g., RAM, ROM, etc.) for storing data for the CPU 1104, a wireless transceiver 1108 (e.g., Bluetooth®, WiFi, RFID, Cellular, etc.) for wirelessly communicating with external devices, electro-mechanical actuator 1110 (e.g., solenoid, motor, etc.) for actuating the latch (e.g. retracting/extending the pawl), a battery 1112 (e.g., rechargeable, replaceable, etc.) for powering the wireless latch module 101, a power circuit 1116 (e.g., charging circuit, voltage regulator, etc.) for charging the battery 1112 from external source 1126 via power port 1124 (e.g., micro-USB) and supplying conditioned voltage to the components of the wireless latch module 102, internal sensors (e.g., accelerometer) for detecting movement and orientation of the wireless latch module 102, external sensors 1120 for measuring physical parameters (e.g., temperature, humidity, vibration, etc.) in or associated with the container/room that is being secured by the latch 102, a sensor port 1118 for connecting the external sensors 1120 to the wireless latch module 102, an RFID tap point 1122 for tapping or interaction with an RFID card, and knob (e.g., rotatable, lever, etc.) for providing user interface to the wireless latch module 102. It is noted that the specific electrical interconnections between these components are not expressly shown in FIG. 11 for the sake of clarity. Such electrical interconnections would be apparent to those skilled in the art. The operation of the wireless latch module 102 is described for example, in U.S. Patent App. No. 63/224,310(SOUT-723USP) to Southco, Inc., which is incorporated by reference herein in its entirety.

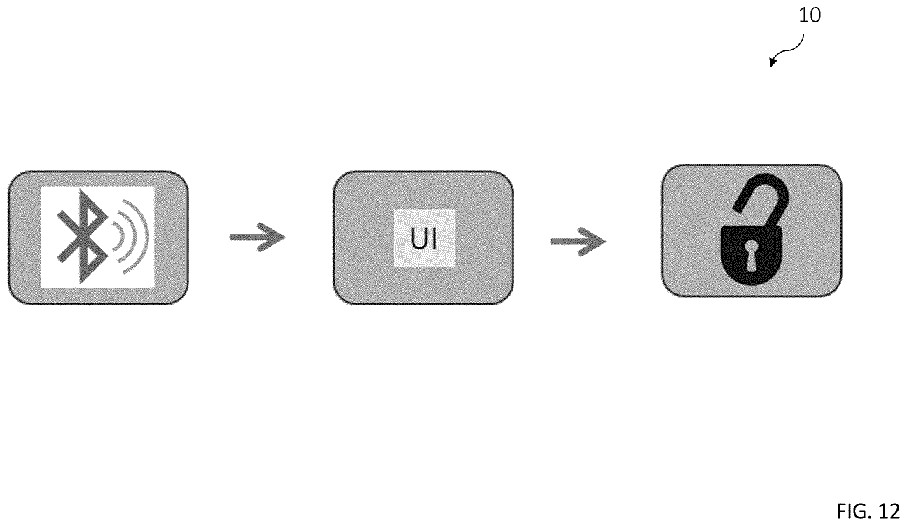

FIG. 12 is a system diagram of an embodiment of a secure wireless remote actuator system 10 according to another embodiment of the invention. Unlike the systems illustrated in FIGS. 3 and 9, the functions of the user interface 100 in this configuration are performed by an associated proprietary mobile application (or “app”) (e.g., a computer program, algorithm, or software application) downloaded to, and installed on, a “smart” mobile device, such as mobile phone, tablet, smart watch, etc., for example.

In the system illustrated in FIG. 12, the user first enables the operation of the remote actuator 200 by activating power to actuate the motor 304 (FIG. 10), and to allow input from the sensors 802 (e.g., FSR), using the app. Alternatively, a firmware or software code embedded into the microprocessor CPU 804 or programmed into the memory 808, which can be integrated into the microprocessor CPU 804, can automatically check the connection and execute an authorization logic. The system illustrated in FIG. 12 is “secure” in the sense that the app typically requires user credentials (e.g., login and/or authentication) and can be stored on a mobile phone or tablet, for example, that may also require user credentials to generally access any content on the mobile device. As described above, the sensors 802 (e.g., FSR) on the remote actuator 200 and the app can communicate with each other via a standard wireless protocol, such a Bluetooth® protocol, for example. After input from the sensors 802 (e.g., FSR) is enabled, the wireless transmitter 1002 of the remote actuator 200 (FIG. 10) transmits the encoded signals, by the encoder 1004 (or the MCU), to the wireless receiver 1006 of the latch module 102. The wireless receiver 1006 decodes the encoded signals to provide a suitable signal for the operation of the driver (e.g., motor controller 306 in FIG. 3) and the motor of the latch module 102.

In another embodiment of a secure wireless remote actuator system 10, the user can wirelessly unlock or lock the latch module 102 via the app on the mobile device, using standard wireless protocol, such a Bluetooth® protocol, for example, without enabling input the sensors 802 (e.g., FSR).

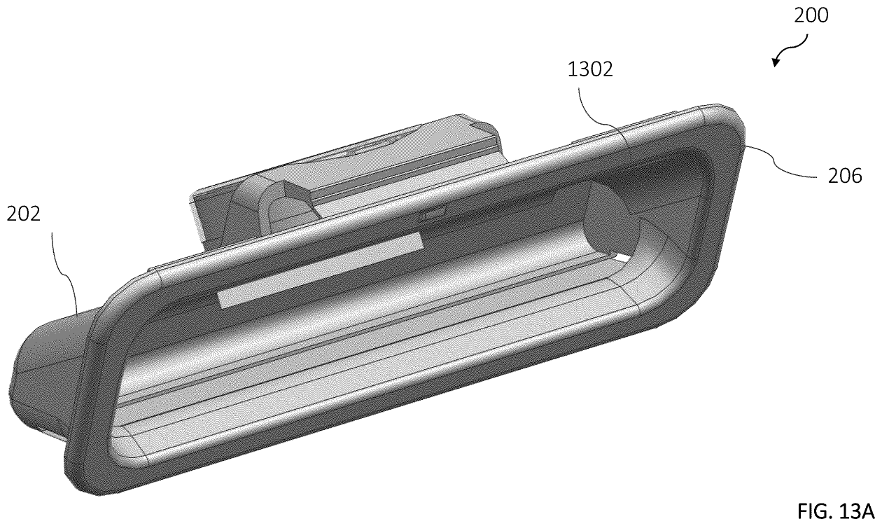

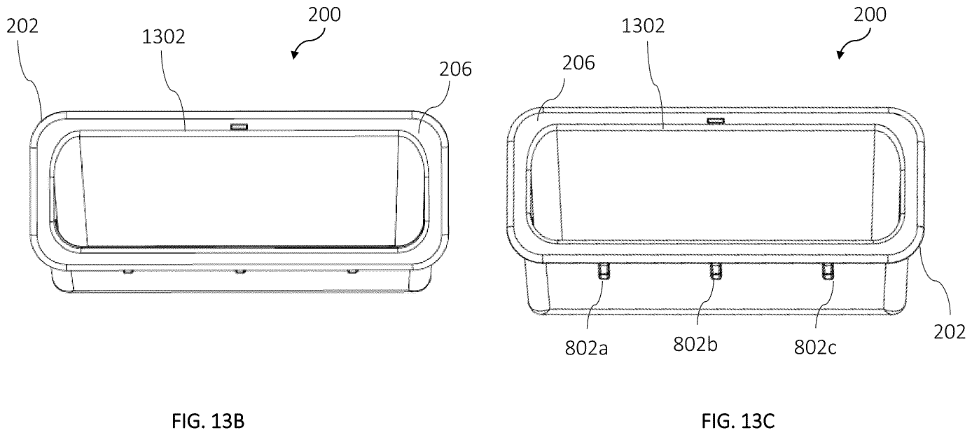

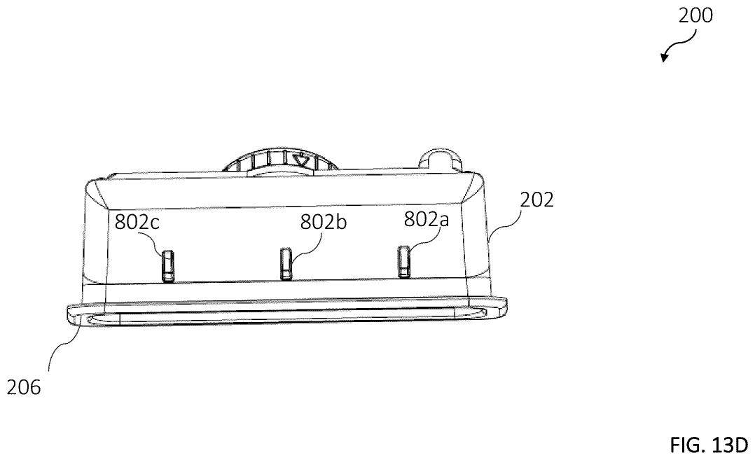

FIGS. 13A-13C show a front perspective view of a remote wireless actuator 200 according to another embodiment of the invention. Similar to the embodiment of FIG. 2A, the remote actuator 200 of FIGS. 13A-13C include a housing 202 defining an interior space for accommodating various components of the system 10. The housing 202 includes a front face 206. However, instead of the handle 204 in FIG. 2A that is configured for gripping by a user, the remote actuator 200 of FIGS. 13A-13C is configured to be actuated by the user's touch (or pressure) applied to the internal portion of the top frame 1302 of the housing 202, or by the user's presence in the proximity of the remote actuator 200.

One or more sensors 802a, 802b, 802c (also shown in, and described with reference to, FIG. 8 as sensor 802) can be arranged on the internal portion of the top frame 1302 of the housing 202), for example, such that the user can touch or press on, or be detected in the proximity of, these sensors. Alternatively, the sensors 802a, 802b, 802c can be embedded into the PCB 704. Other than the different configuration, the operation of the remote actuator 200 of FIGS. 13A-13C is the same as the operation of the remote actuator 200 of FIG. 2A.

FIG. 13D shows a top view of a remote electronic wireless actuator according to an embodiment of the invention.

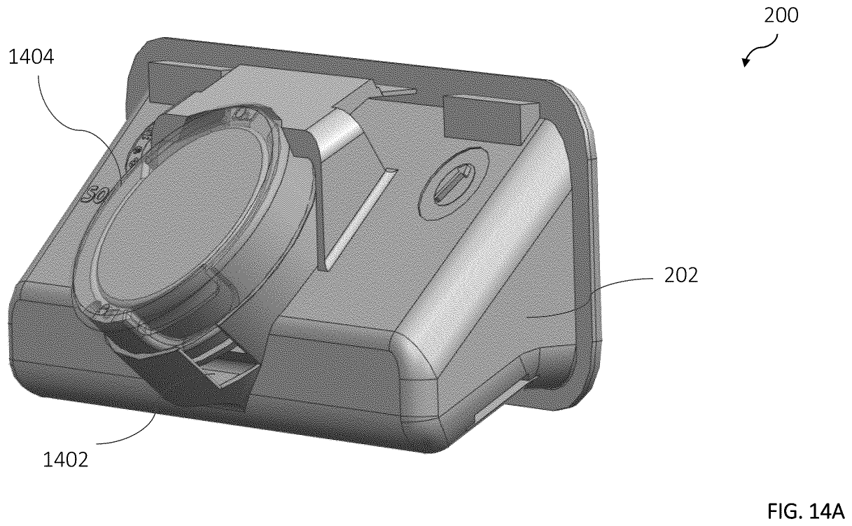

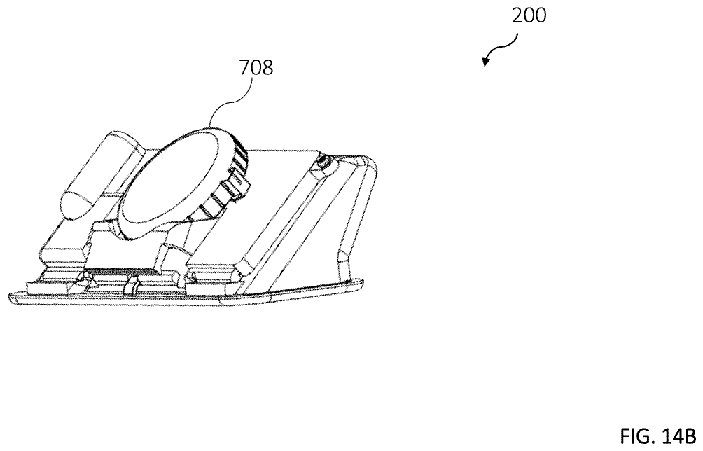

FIGS. 14A and 14B show a rear perspective view of the remote wireless actuator 200 of FIGS. 13A-13C. The back of the housing 202 of the remote actuator 200 defines an interior space with a recessed area 1402 for accommodating various components of the system 10. For example, the recessed areas 1402 may have a round shape configured to house a battery or wiring connecting the remote wireless actuator 200 to the latch module 102. The recessed area 1402 may have an external cover 1404 to protect the battery and any other components housed in the recessed area 1402 of the remote wireless actuator 200.

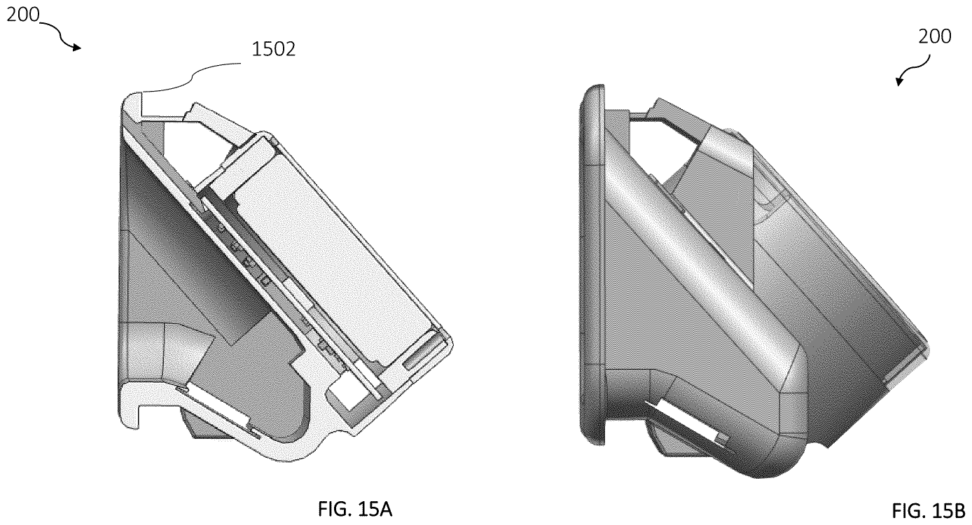

FIGS. 15A and 15B show a side perspective view of the remote wireless actuator 200 of FIGS. 13A-13C. As illustrated in FIGS. 15A-15B, the remote actuator 200 can include on a top side, or on all sides, of the front face 206 (FIG. 2A) of the housing 202 a channel 1502 configured to operate as a light pipe for conducting light from the LEDs of the display 408. If light waves of various wavelengths enter the light pipe 1502, they may be mixed to form a new color. The light in the light pipe 1502 may be visible through an opening of, or diffused by, a clear cover arranged on the remote actuator 200. In this way, the LEDs of the display 408 may be electrically connected to the microprocessor CPU 804 of the remote actuator 200, for example, and may be operated according to a logic indicating a current state of the sensors 802 (e.g., enabled or disabled) or the current status of the latch module 102 (e.g., locked or unlocked), for example. Additional wires can be included to the wire bundle of FIG. 4, for example, so that the status of the latch module 102 can be supplied to the remote actuator 200 to turn on the LEDs when the latch is opened or closed.

When the display 408 includes LCD or E-ink, the display 408 can be mounted on the remote wireless actuator 200 in such a way that it can be viewed by the user when operating, or in the proximity of, the remote wireless actuator 200.

Aspects of the invention include:
1. A remote electronic actuator system comprising:
   a user interface configured to receive at least one input from a user to operate a latch configured to latch a secured space; and
   a wired or a wireless communications interface configured to connect the user interface to the latch.
2. The remote electronic actuator system of aspect 1, wherein the communications interface comprises at least one cable or at least one wire.
3. The remote electronic actuator system of aspect 1, wherein the communications interface comprises a wireless communications protocol.
4. The remote electronic actuator system of aspect 3, wherein the wireless communications protocol is at least one of a cellular communications protocol or a Radio Frequency (RF) communications protocol.
5. The remote electronic actuator system of aspect 1, wherein the communications interface comprises a short-range wireless communications protocol.
6. The remote electronic actuator system of aspect 5, wherein the short-range wireless communications protocol is at least one of a Bluetooth® communications protocol, Near Field Communications protocol, a WiFi communications protocol, ZigBee, Z-Wave, long range (LoRa), or LoRaWAN communications protocol.
7. The remote electronic actuator system of aspect 1, wherein the user interface comprises at least one of a handle trigger or a sensor.
8. The remote electronic actuator system of aspect 7, wherein the sensor is a resistive touch sensor.
9. The remote electronic actuator system of aspect 7, wherein the sensor is a Force Sensitive Resistor (FSR).
10. The remote electronic actuator system of aspect 9, further comprising at least one printed circuit board operatively connected to the FSR and a display configured to display information about the operation of the latch.
11. The remote electronic actuator system of aspect 10, wherein the at least one printed circuit board is part of the user interface.
12. The remote electronic actuator system of aspect 10, wherein the user interface is configured to unlock or lock the latch when the user enables the remote electronic actuator system to allow input from the FSR.
13. The remote electronic actuator system of aspect 7, wherein the sensor is a capacitive touch sensor or a proximity sensor.
14. The remote electronic actuator system of aspect 7, wherein the sensor is an infrared proximity sensor.
15. The remote electronic actuator system of aspect 1, further comprising a circuit configured to convert an input from the user interface into a signal configured to operate the latch.
16. The remote electronic actuator system of aspect 15, wherein the display comprises at least one of a liquid-crystal display (LCD), E-ink, or a light-emitting diode (LED).
17. The remote electronic actuator system of aspect 16, wherein the communications interface comprises at least one additional wire configured to supply latch status to the user interface by updating a status of the at least one LCD, E-ink, or LED when the latch is opened or closed.
18. The remote electronic actuator system of aspect 1, wherein the latch comprises a motor and a motor controller.
19. The remote electronic actuator system of aspect 18, wherein the latch comprises a power supply and a cable extending from the power supply to the motor.
20. The remote electronic actuator system of aspect 19, wherein the power supply includes an integrated power source with at least one battery.
21. The remote electronic actuator system of aspect 9, further comprising at least one printed circuit board operatively connected to the FSR, a display configured to display information about the operation of the latch, and a wireless transceiver configured to perform wireless communication with the latch.
22. The remote electronic actuator system of aspect 21, wherein the at least one printed circuit board is part of the user interface.
23. The remote electronic actuator system of aspect 20, wherein the user interface is configured to enable the remote electronic actuator system to allow input from the FSR when the user uses an application on a mobile device and, after the input from the FSR is enabled, the user interface is configured to unlock or lock the latch when the user touches the FSR.
24. The remote electronic actuator system of aspect 9, further comprising:
   a printed circuit board operatively connected to the FSR, the printed circuit board including a wireless transmitter configured to perform wireless communication with the latch, a wireless receiver configured to perform wireless communication with the user interface, and a switch; and
   a display configured to display information about the operation of the latch.
25. The remote electronic actuator system of aspect 24, wherein the printed circuit board is part of the user interface.
26. The remote electronic actuator system of aspect 24, wherein the printed circuit board comprises a power supply.
27. The remote electronic actuator system of aspect 26, wherein the at least one printed circuit board is part of the latch.
28. The remote electronic actuator system of aspect 28, wherein the user interface is configured to wirelessly unlock or lock the latch via the application on the mobile device, without the user touching the FSR.
29. The remote electronic actuator system of aspect 7, further comprising a remote actuator operatively connected to the latch and configured to move the latch between a latched condition and an unlatched condition.
30. The remote electronic actuator system of aspect 29, wherein the remote actuator comprises:
   a housing, wherein the at least one sensor is configured to be arranged in a sensor port of the housing;
   a display comprising at least one of a liquid-crystal display (LCD), E-ink, or a light-emitting diode (LED), the display configured to display information about the operation of the latch; and
   at least one recessed areas on a back side of the housing, the at least one recessed area configured to house a battery and at least one printed circuit board comprising a processor and a wireless transceiver, wherein the wireless transceiver is operatively connected to the at least one sensor, the wireless transceiver being configured to perform wireless communication with the latch and with one or more wireless components external to the latch.
31. The remote electronic actuator system of aspect 30, wherein the remote actuator further comprises a channel on a top side of the housing, the channel configured to operate as a light pipe conducting light from the at least one of the LCD, E-ink, or the LED of the display.
32. The remote electronic actuator system of aspect 24, wherein the user interface comprises a handle trigger including a switch actuator, the handle trigger being arranged on a front face of the remote electronic actuator, and wherein the switch is arranged on a rear side of the remote electronic actuator.
33. The remote electronic actuator system of aspect 32, wherein the rear side of the remote electronic actuator comprises a lever arranged in a location corresponding to the location of the switch actuator, the lever being operatively connected to the switch.
34. The remote electronic actuator system of aspect 24, wherein the switch is a microswitch.
35. A latch system configured for remote actuation comprising:
   an electronic actuator;
   a user interface coupled to the electronic actuator and configured to receive at least one input from a user;
   a latch configured to latch a secured space; and
   a wired or a wireless communications interface configured to connect the user interface to the latch.

While preferred embodiments of the invention have been shown and described herein, it will be understood that such embodiments are provided by way of example only. Numerous variations, changes and substitutions will occur to those skilled in the art without departing from the spirit of the invention. Accordingly, it is intended that the appended claims cover all such variations as fall within the spirit and scope of the invention.

What is claimed is:

1. A remote electronic actuator system comprising:
a user interface configured to receive at least one input from a user to operate a latch configured to latch a secured space; and
a wired or a wireless communications interface configured to connect the user interface to the latch.

2. The remote electronic actuator system of claim 1, wherein the communications interface comprises at least one cable or at least one wire.

3. The remote electronic actuator system of claim 1, wherein the communications interface comprises a wireless communications protocol.

4. The remote electronic actuator system of claim 3, wherein the wireless communications protocol is at least one of a cellular communications protocol or a Radio Frequency (RF) communications protocol.

5. The remote electronic actuator system of claim 1, wherein the communications interface comprises a short-range wireless communications protocol.

6. The remote electronic actuator system of claim 5, wherein the short-range wireless communications protocol is at least one of a Bluetooth® communications protocol, Near Field Communications protocol, a WiFi communications protocol, ZigBee, Z-Wave, long range (LoRa), or LoRaWAN communications protocol.

7. The remote electronic actuator system of claim 1, wherein the user interface comprises at least one of a handle trigger or a sensor.

8. The remote electronic actuator system of claim 7, wherein the sensor is a resistive touch sensor.

9. The remote electronic actuator system of claim 7, wherein the sensor is a Force Sensitive Resistor (FSR).

10. The remote electronic actuator system of claim 9, further comprising at least one printed circuit board operatively connected to the FSR and a display configured to display information about the operation of the latch.

11. The remote electronic actuator system of claim 10, wherein the at least one printed circuit board is part of the user interface.

12. The remote electronic actuator system of claim 10, wherein the user interface is configured to unlock or lock the latch when the user activates the FSR by touching the FSR.

13. The remote electronic actuator system of claim 7, wherein the sensor is a capacitive touch sensor or a proximity sensor.

14. The remote electronic actuator system of claim 7, wherein the sensor is an infrared proximity sensor.

15. The remote electronic actuator system of claim 1, further comprising a circuit configured to convert an input from the user interface into a signal configured to operate the latch.

16. The remote electronic actuator system of claim 15, wherein the display comprises at least one of a liquid-crystal display (LCD), E-ink, or a light-emitting diode (LED).

17. The remote electronic actuator system of claim 16, wherein the communications interface comprises at least one additional wire configured to supply latch status to the user interface by updating a status of the at least one LCD, E-ink, or LED when the latch is opened or closed.

18. The remote electronic actuator system of claim 1, wherein the latch comprises a motor and a motor controller.

19. The remote electronic actuator system of claim 18, wherein the latch comprises a power supply and a cable extending from the power supply to the motor.

20. The remote electronic actuator system of claim 19, wherein the power supply includes an integrated power source with at least one battery.

21. The remote electronic actuator system of claim 9, further comprising at least one printed circuit board operatively connected to the FSR, a display configured to display information about the operation of the latch, and a wireless transceiver configured to perform wireless communication with the latch.

22. The remote electronic actuator system of claim 21, wherein the at least one printed circuit board is part of the user interface.

23. The remote electronic actuator system of claim 20, wherein the user interface is configured to enable the remote electronic actuator system to allow input from the FSR when the user uses an application on a mobile device and, after the input from the FSR is enabled, the user interface is configured to unlock or lock the latch when the user touches the FSR.

24. The remote electronic actuator system of claim 9, further comprising:
a printed circuit board operatively connected to the FSR, the printed circuit board including a wireless transmitter configured to perform wireless communication with the latch, a wireless receiver configured to perform wireless communication with the user interface, and a switch; and
a display configured to display information about the operation of the latch.

25. The remote electronic actuator system of claim 24, wherein the printed circuit board is part of the user interface.

26. The remote electronic actuator system of claim 24, wherein the printed circuit board comprises a power supply.

27. The remote electronic actuator system of claim 26, wherein the at least one printed circuit board is part of the latch.

28. The remote electronic actuator system of claim 9, wherein the user interface is configured to wirelessly unlock or lock the latch via the application on the mobile device.

29. The remote electronic actuator system of claim 7, further comprising a remote actuator operatively connected to the latch and configured to move the latch between a latched condition and an unlatched condition.

30. The remote electronic actuator system of claim 29, wherein the remote actuator comprises:
a housing, wherein the at least one sensor is configured to be arranged in a sensor port of the housing;
a display comprising at least one of a liquid-crystal display (LCD), E-ink, or a light-emitting diode (LED), the display configured to display information about the operation of the latch; and
at least one recessed areas on a back side of the housing, the at least one recessed area configured to house a battery and at least one printed circuit board comprising a processor and a wireless transceiver, wherein the wireless transceiver is operatively connected to the at least one sensor, the wireless transceiver being configured to perform wireless communication with the latch and with one or more wireless components external to the latch.

31. The remote electronic actuator system of claim 30, wherein the remote actuator further comprises a channel on a top side of the housing, the channel configured to operate as a light pipe conducting light from the at least one of the LCD, E-ink, or the LED of the display.

32. The remote electronic actuator system of claim 24, wherein the user interface comprises a handle trigger including a switch actuator, the handle trigger being arranged on a front face of the remote electronic actuator, and wherein the switch is arranged on a rear side of the remote electronic actuator.

33. The remote electronic actuator system of claim 32, wherein the rear side of the remote electronic actuator comprises a lever arranged in a location corresponding to the location of the switch actuator, the lever being operatively connected to the switch.

34. The remote electronic actuator system of claim 24, wherein the switch is a microswitch.

35. A latch system configured for remote actuation comprising:
an electronic actuator;
a user interface coupled to the electronic actuator and configured to receive at least one input from a user;
a latch configured to latch a secured space; and
a wired or a wireless communications interface configured to connect the user interface to the latch.
